(19) United States
(12) Patent Application Publication
(10) Pub. No.: US 2010/0072749 A1
(43) Pub. Date: Mar. 25, 2010

(54) CLAMP COLLAR

(75) Inventor: Bret VOELKEL, Jasper, IN (US)

Correspondence Address: Vedder Price, PC, 875 15th Street, NW, Suite 725, Washington, DC, 20005, US

(73) Assignee: ORIC HOLDING, L.P., JASPER, IN (US)

(21) Appl. No.: 12/234,773

(22) Filed: Sep. 22, 2008

(51) Int. Cl. F16L 19/00; B21D 39/00

(52) U.S. Cl. 285/373; 29/455.1

(57) ABSTRACT

A clamp assembly for clamping together two support members of, for example, a roll bar or roll cage assembly, a method for assembling a roll bar or roll cage assembly using such a clamp assembly, and a clamp device that is part of the clamp assembly.

### BACKGROUND OF THE INVENTION

1. Field of the Invention

The present invention relates to a clamp device for use, for example, in assembling a roll bar or roll cage assembly for a vehicle.

2. Background of the Technology

A roll bar is a single curved or generally U-shaped bar that is mounted behind the driver of a vehicle to provide roll-over protection. Roll bars frequently include additional support members to prevent the roll bar from collapsing in the event of a roll-over. The additional support members are usually attached to the roll bar by welding.

A roll cage assembly may be a specially constructed frame built in or around the cab of a vehicle, such as a race car, to protect the occupants from being injured in the event of a roll-over. A roll cage also provides increased structural rigidity to a vehicle by connecting key stress points of the vehicle together with the roll cage assembly. There are many different roll cage designs depending on the type of vehicle on which the roll cage is used. Typically, a roll cage assembly is assembled by welding together a number of support members.

### SUMMARY OF THE INVENTION

According to a first broad aspect of the present invention, there is provided a device comprising: a clamping component comprising two opposing jaws, each of the jaws including: a proximal end opposing the proximal end of the other jaw and separated from the proximal end of the other jaw by a proximal gap; a distal end; and a contacting region opposing the contacting region of the other jaw; and a pivot component connected to the respective distal ends of the two jaws and including at least part of a pivoting mechanism for pivotably mounting a pivot mount on the pivot component, wherein when the opposing proximal ends of the two jaws are forced towards each other, the opposing contacting regions of the two jaws at least substantially complementarily clamp a first support member located between the opposing contacting regions to thereby hold the clamp component to the first support member.

According to a second broad aspect of the present invention, there is provided a method comprising the following steps: (a) pivoting a pivot mount and/or a clamp device of a clamp assembly to a desired angle with respect to each other; (b) fixing the clamp assembly at the desired angle by preventing the pivot mount from pivoting relative to the clamp device; (c) clamping the clamp device to the first support member by forcing towards each other respective proximal ends of two jaws of the clamp device so that opposing contacting regions of the two jaws at least substantially complementarily clamp the first support member between the two jaws; and (d) mounting the pivot mount on a second support member, wherein after steps (a), (b), (c) and (d) are performed, the clamp assembly connects the first and second support members to each other in a desired fixed position.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a top perspective view of a clamp component according to one embodiment of the present invention;

FIG. 2 is a top view of the clamp component of FIG. 1 with shadow lines to show details that are not visible in this view;

FIG. 3 is a front side view of the clamp component of FIG. 1;

FIG. 4 is a rear or back side view of the clamp component of FIG. 1;

FIG. 5 is a top perspective view of a pivot piece according to one embodiment of the present invention;

FIG. 6 is a top view of the pivot piece of FIG. 5;

FIG. 7 is a side view of the pivot piece of FIG. 5;

FIG. 8 is a front side view of a pivot mount according to one embodiment of the present invention with shadow lines to show details that are hidden in this view;

FIG. 9 is sectional view of the pivot mount of FIG. 8 along section line 9-9 with shadow lines to show details that are hidden in this view;

FIG. 10 is a top view of the pivot mount of FIG. 8 with shadow lines to show details that are hidden in this view;

FIG. 11 is a perspective view of a clamp assembly according to one embodiment of the present invention used to connect two hollow tubular support members;

FIG. 12 is a side view of the clamp assembly and two hollow tubular support members of FIG. 11;

FIG. 13 is a top sectional view of a clamp assembly according to one embodiment of the present invention used to connect two hollow tubular support members;

FIG. 14 is a side sectional view of a clamp assembly according to one embodiment of the present invention used to connect two hollow tubular support members;

FIG. 15 is an image of a clamp assembly according to one embodiment of the present invention used to connect two hollow tubular support members;

FIG. 16 is an image of the clamp assembly and hollow tubular support members of FIG. 15;

FIG. 17 is an image of the clamp assembly and hollow tubular support members of FIG. 15; and

FIG. 18 is an image of the clamp assembly and hollow tubular support members of FIG. 15.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, directional terms such as: “front”, “rear”, “top”, “bottom”, “upper”, “lower”, “above”, “below”, “left”, “right”, “horizontal”, “vertical”, “upward”, “downward”, “proximal”, “distal,” etc., are merely used for convenience in describing the various embodiments of the present invention.

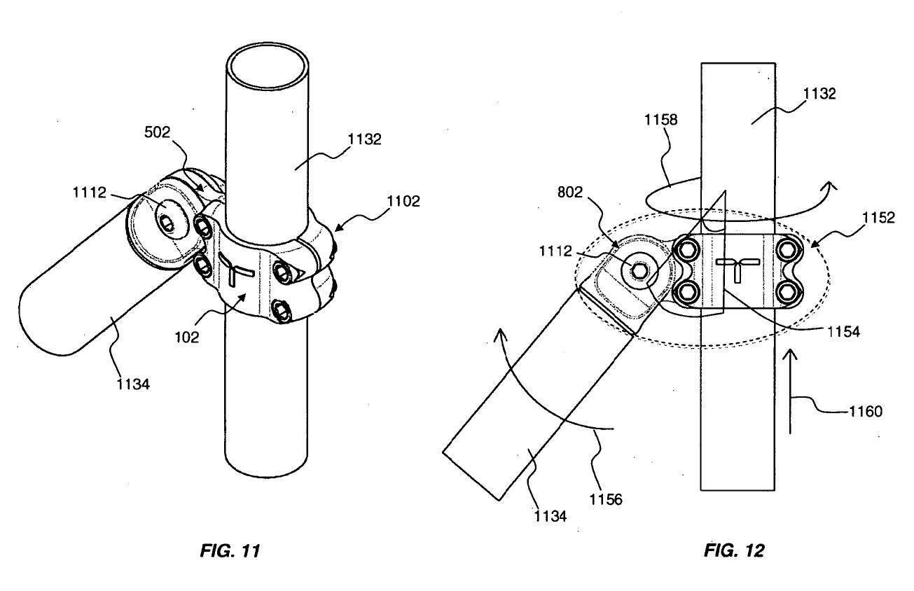

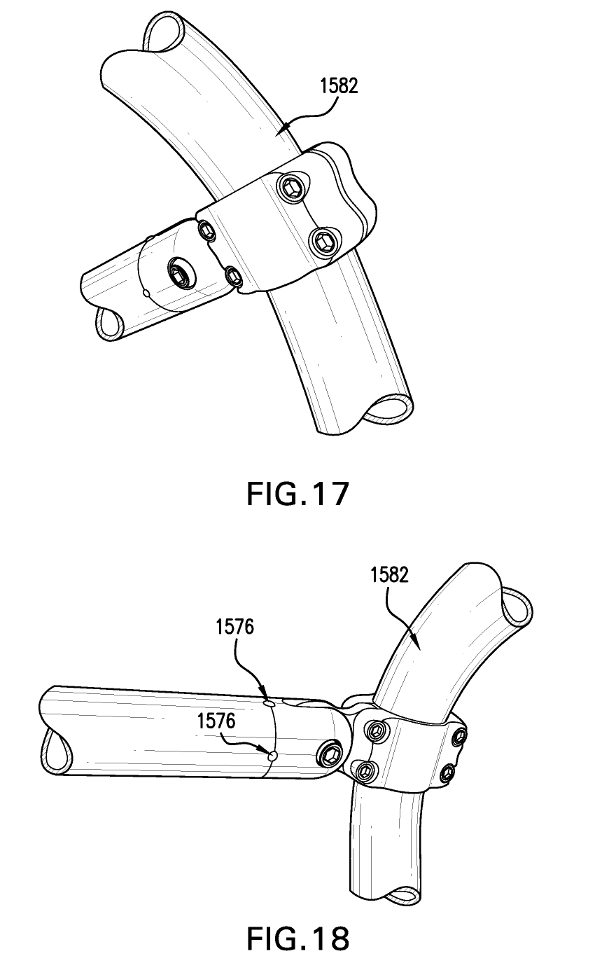

For the purposes of the present invention, the term “complementarily” refers to clamping regions of a clamp device/assembly that have interior surfaces that are complementary to the exterior surface of the region of the support member (e.g., tubular support member) to which the clamping regions are clamped. FIGS. 11, 12, 13 and 14 show an example of clamping regions that complementarily clamp a tubular support member. Although not shown in the drawing figures, the clamp and support members may have complementary combinations of features such as one or more ridges and grooves, complementary raised regions and recessed regions, etc. that help align and/or position the clamping regions on the support members. When the support members have cross-sectional shapes other than the circular cross-sectional shapes of the support members shown in FIGS. 11, 12, 13, 14, 15, 16, 17 and 18, the clamping regions may have various shapes to provide complementary clamping to such support members.

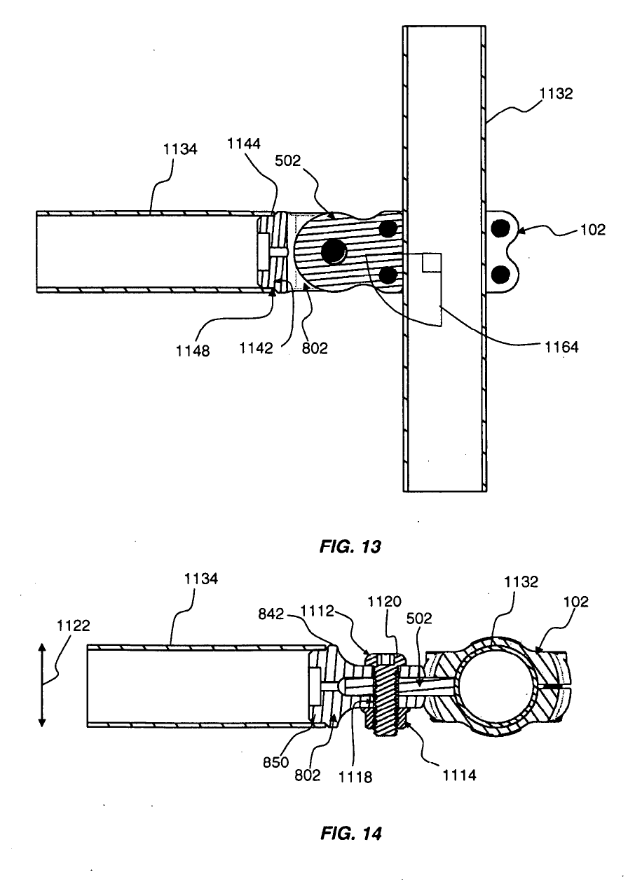

For the purposes of the present invention, the term “pivotably mounted” refers to two items that are connected so that at least one of the items may pivot relative to the other item at least during assembly. For example, FIGS. 11, 12, 13 and 14 shows a pivot mount pivotably mounted on a pivot piece of a clamp device. FIGS. 11, 12, 13 and 14 also show a first tubular member that is pivotably mounted on a second tubular support member by using the pivot mount mounted on the first tubular support member, with the clamp device being mounted on the second tubular support member. Once the support members are at the desired angle, for example, a non-right angle in FIGS. 11 and 12 or a right angle in FIGS. 13 and 14, the support members may be fixed at the desired angle by tightening the screws connecting the pivot mount to the pivot piece of the clamp device.

For the purposes of the present invention, the term “pivoting torque” refers to a torque exerted in a pivoting direction a support member (e.g., tubular support member) on which a pivot mount is mounted. An example of a twisting torque is shown in FIG. 12 and described in more detail below.

For the purposes of the present invention, the term “resists” refers to the ability of an embodiment of a clamp device/clamp assembly of the present invention to resist forces and/or torques exerted on the clamp device/clamp assembly, on the support member (e.g., tubular support member) to which the clamp device/clamp assembly is clamped and on support members that are connected by a clamp device/clamp assembly without the clamp assembly/clamp device moving relative to the support member(s) and/or the connected support members moving relative to each other.

For the purposes of the present invention, the term “sliding force” refers to a force exerted to attempt to slide a support member (e.g., tubular support member) relative to a clamp device clamped on the support member. An example of a sliding force is shown in FIG. 12 and described in more detail below.

For the purposes of the present invention, the term “substantially complementarily” refers to clamping regions that are similar but not exact complements of the exterior surface of the clamping region to which the clamping regions are clamped. Clamping regions may only substantially complementarily clamp a support member (e.g., tubular support member) for a variety of reasons. For example, the clamping regions may be designed for clamping a straight region of a tubular support member, but are clamped to a curved region of a tubular support member, as shown, for example, in FIGS. 16, 17 and 18. The clamping regions may also be designed for clamping a support member (e.g., tubular support member) of a diameter that is slightly different than the diameter of the support member being clamped. The surface of the support member may also not be perfectly smooth due to wear, imperfections, etc. Also, the surface of the clamping regions may include ridges or other features designed to provide more secure gripping of the support member. There are also a variety of other reasons why a clamping region may only substantially complementarily clamp a support member instead of complementarily clamping a support member.

For the purposes of the present invention, the term “twisting torque” refers to a torque exerted in a twisting direction on a support member (e.g., tubular support member) relative to a clamp device clamped on the tubular support member. An example of a twisting torque is shown in FIG. 12 and described in more detail below.

For the purposes of the present invention, the term “unibody” refers to a component or device made as a single part.

### Description

The the clamp device of present invention may minimize or eliminate the use of welding in assembling a roll bar or roll cage assembly allows such an assembly to be put together without requiring the interior panels of a vehicle to be protected. Also, assembling a roll bar or roll cage assembly using the clamp device of the present invention may not require special welding skills.

In some embodiments, the clamp device of the present invention may be used to assemble a roll bar or roll cage assembly without the need to disassemble the interior of a vehicle to perform proper welds as required with welded assemblies.

In some embodiments, the integrity of the connection between two support members connected by the clamp device of the present invention may be easier to check than a welded connection between two support members. Also, the clamp device of the present invention provides a connection between two support members that distributes the transmitted force through a relatively large area instead of concentrating the transmitted force in the thin profile of a welded tab as is done in welded assemblies.

Because the thickness and material of a vehicle can vary greatly, it may be easier to verify the integrity of the connections made by a clamp assembly of the present invention in comparison with the integrity of the connections in a welded roll cage assembly. Also, unlike many welded roll cage assemblies, a roll assembly put together using a clamp assembly of the present invention may be easily removed from a vehicle if necessary. In addition, the clamp assembly of the present invention in at least some embodiments allows a roll cage to be designed and installed in a variety of configurations and readily changed if necessary.

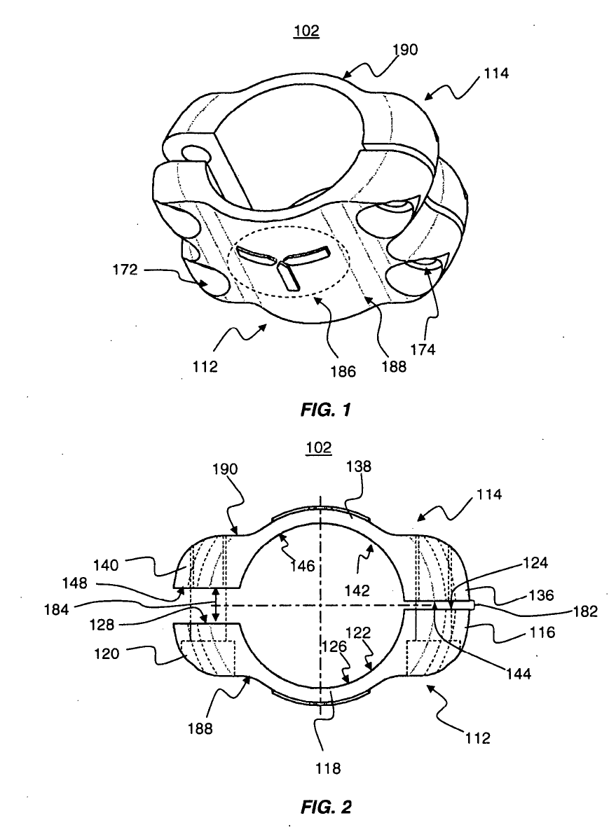

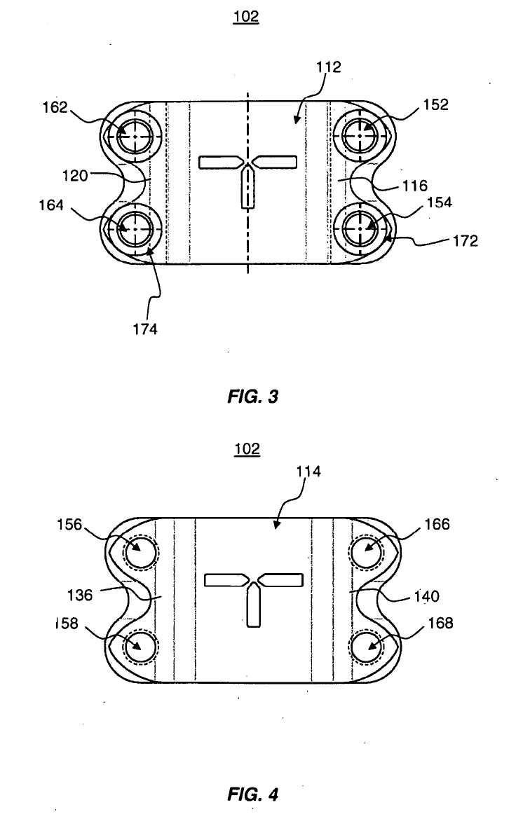

FIGS. 1, 2, 3 and 4 show a clamp component 102 according to one embodiment of the present invention including a front jaw 112 and a rear jaw 114. Front jaw 112 includes a proximal end 116, a curved contacting region 118, a distal end 120 and a front jaw interior surface 122. Front jaw interior surface 122 includes a proximal interior surface 124, a curved interior contacting surface 126 and a distal interior surface 128. Interior contacting surface 126 is a part of contacting region 118. Rear jaw 114 includes a proximal end 136, a curved contacting region 138, a distal end 140 and a rear jaw interior surface 142. Rear interior surface 142 includes a proximal interior surface 144, an interior contacting surface 146 and a distal interior surface 148. Interior contacting surface 146 is a part of contacting region 138.

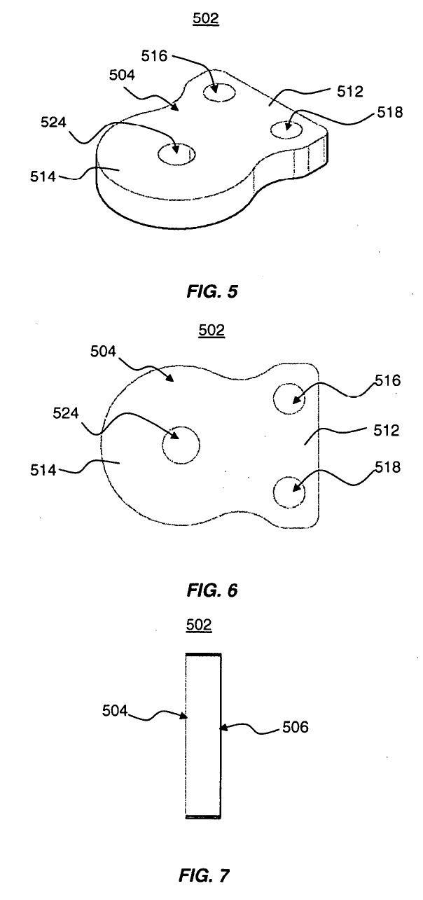

Front jaw 112 includes proximal apertures 152 and 154 that are aligned with respective proximal apertures 156 and 158 of rear jaw 114 to allow screws (not shown in FIGS. 1, 2, 3 and 4) to be inserted through aligned proximal apertures 152 and 156 and through aligned proximal apertures 154 and 158, respectively. Front jaw 112 includes distal apertures 162 and 164. Rear jaw 114 includes distal apertures 166 and 168. Proximal apertures 152 and 154 and distal apertures 162 and 164 include recesses 172 with shoulders 174 against which the screw heads of the screws may be screwed flush. Clamp component 102 includes a proximal gap 182 between opposing proximal ends 116 and 136 to allow opposing proximal interior surfaces 124 and 144 to be forced towards each other without coming into contact with each other i.e. “bottoming out”. Clamp component 102 includes a distal gap 184 between opposing distal ends 120 and 140 to allow a pivot piece, such as the pivot piece of FIGS. 5, 6 and 7, described in detail below, be mounted between distal ends 120 and 140. Clamp component 102 also includes a raised decorative indicia 186 on exterior surfaces 188 and 190 of front jaw 112 and rear jaw 114, respectively.

FIGS. 5, 6 and 7 show a relatively flat pivot piece 502 according to one embodiment of the present invention including having two identical sides 504 and 506. Pivot piece 502 includes a fixed mounting portion 512 and mostly circular-shaped pivotable mounting portion 514. Fixed mounting portion 512 includes apertures 516 and 518. Pivotable mounting portion 514 includes pivot aperture 524. Pivot piece 502 is designed to be inserted into distal gap 184 of clamp component 102, so that that aperture 516 of pivot piece 502 is aligned with distal aperture 162 of front jaw 112 and with distal aperture 166 of rear jaw 114 and so that aperture 518 of pivot piece 502 is aligned with distal aperture 164 of front jaw 112 and with distal aperture 168 of rear jaw 114, as shown in FIGS. 11, 12, 13 and 14, described in more detail below.

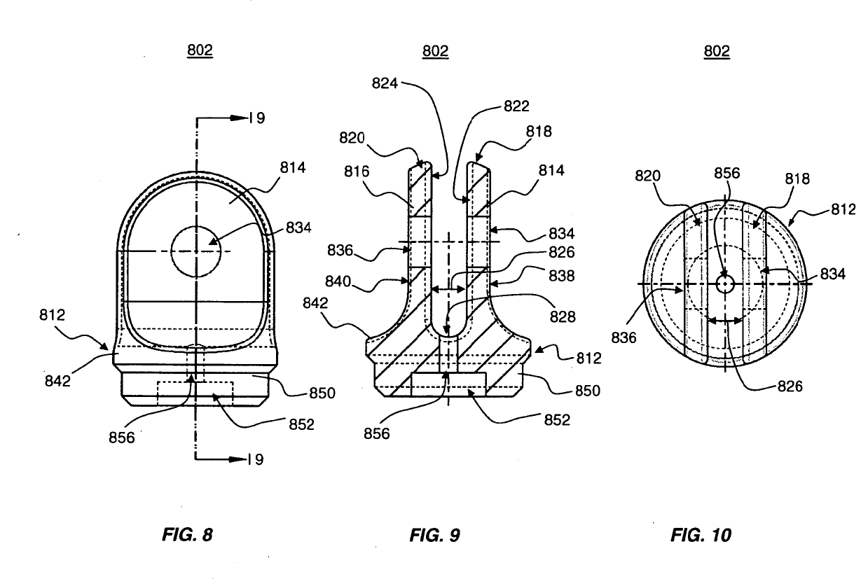

FIGS. 8, 9 and 10 show a pivot mount 802 according to one embodiment of the present invention. Pivot mount 802 includes a circular base 812 and two substantially flat support structures 814 and 816 having respectively semicircular tops 818 and 820. Support structures 814 and 816 extend substantially perpendicularly from base 812. Support structures 814 and 816 have respective interior opposing or opposed parallel faces 822 and 824 separated from each other by a gap 826 for most of their length. Faces 822 and 824 come together at a U-shaped region 828 on base 812. Support structures have respective pivot apertures 834 and 836 that are aligned with each other. Support structures 814 and 816 have respective exterior faces 838 and 840 that are curved where support structures 814 and 816 join base 812 at circular base lip 842. Base 812 has a base bottom 850 that is smaller in diameter than base lip 842. Base 812 includes a recess 852 in base bottom and an aperture 856 that extends through base 812 from base bottom 840 to U-shaped region 828.

FIGS. 11, 12, 13 and 14 show a clamp device 1102 according to the present invention made by assembling together clamp component 102 and pivot piece 502. Pivot piece 502 is mounted in clamp component 102 by screws (not shown in FIGS. 11, 12, 13 and 14) that are inserted through distal aperture 162 of front jaw 112, aperture 516 of pivot piece 502 and distal aperture 166 of rear jaw 114, respectively, and through distal aperture 164 of front jaw 112, aperture 518 of pivot piece 502 and distal aperture 168 of rear jaw 114, respectively so that the heads of the screws abut against shoulders 174 of apertures 162 and 164.

FIGS. 11, 12, 13 and 14 show pivot mount 802 pivotably mounted on pivot piece 502 and, therefore, pivotably mounted on clamp device 1102 by a screw 1112 and a nut 1114 screwed onto screw 1112. Screw 1112 extends through pivot aperture 524 of pivot piece 502 and pivot apertures 834 and 836 of pivot mount 802 that are aligned with pivot aperture 524. Screw head 1120 and nut 1114 limit the ability of pivot mount 802 to slide on shaft 1116 in the directions shown by double-headed arrow 1126 in FIG. 14.

FIGS. 11, 12, 13 and 14 show contacting interior surface 126 of contacting region 118 of front jaw 112 and contacting interior surface 146 of contacting region 138 complementarily clamping a hollow tubular support member 1132 due to proximal end 116 of front jaw 112 being forced towards proximal end 136 of rear jaw 114. Proximal ends 116 and 136 are forced towards each other by screws (not shown in FIGS. 11, 12, 13 and 14) that are inserted through proximal aperture 152 of front jaw 112 and proximal aperture 156 of rear jaw 114, respectively, and through proximal aperture 154 of front jaw 112 and proximal aperture 158 of rear jaw 114, respectively so that the heads of the screws abut against shoulders 174 of apertures 152 and 154. The screws can be tightened to increase the clamping force exerted by front jaw 112 and rear jaw 114 on hollow tubular support member 1132.

Although not used in the embodiment shown in FIGS. 11, 12, 13 and 14, a nut may be screwed on each of the opposite ends of the screws in apertures 156, 158, 166 and 168 to provide additional tightening/clamping. Also, washers may be used with the screws and/or nuts.

Pivot mount 802 is mounted on hollow tubular support member 1134 by inserting base bottom 850 into support member end 1142 until base lip 842 abuts edge 1144 of end 1142 as shown in FIGS. 13 and 14. Pivot mount 802 is held in place on support member 1134 by welding (not shown for clarity of illustration).

FIGS. 11 and 12 show a clamp assembly comprising clamp device 1102 and pivot mount 802. Clamp assembly 1152 (indicated within the dashed line oval) connects tubular support member 1134 to tubular support member 1132 at a non-right angle 1154. The relative position of tubular support members 1132 and 1134 may be a temporary position during assembly or a fixed position during assembly or after assembly.

The relative position of tubular support members 1132 and 1134 may be fixed by tightening nut 1114 on screw 1112 so that screw head 1120 and nut 1114, exert sufficient force on exterior surfaces 838 and 840 of support structures 814 and 816, respectively, to prevent pivot mount 802 from pivoting relative to pivot piece 502 and clamp device 1102. With tubular support members 1132 and 1134 fixed in place relative to each other and clamp device 1102 clamped on support member 1132, clamp assembly 1152 resists a pivoting torque shown by curved arrow 1156 on tubular support 1134, resists a twisting torque shown by curved arrow 1158 on tubular support member 1132, and resists a sliding force shown by arrow 1160 exerted on tubular support member 1132.

FIGS. 13 and 14 show a clamp assembly comprising clamp device 1102 and pivot mount 802. Clamp assembly 1152 connects tubular support member 1134 to tubular support member 1132 at a right angle 1164. The relative position of tubular support members 1132 and 1134 may be a temporary position during assembly or a fixed position during assembly or after assembly. The relative position of tubular support members 1132 and 1134 may be fixed by tightening nut 1114 on screw 1112 so that screw head 1120 and nut 1114, exert sufficient force on exterior surfaces 838 and 840 of support structures 814 and 816, respectively, to prevent pivot mount 802 from pivoting relative to pivot piece 502 and clamp device 1102.

For simplicity of illustration, only a portion of each the tubular support tubes are shown in FIGS. 11, 12, 13, and 14. The tubular support tubes of a roll bar or roll cage assembly are usually much longer than the clamp device/assembly of the present invention.

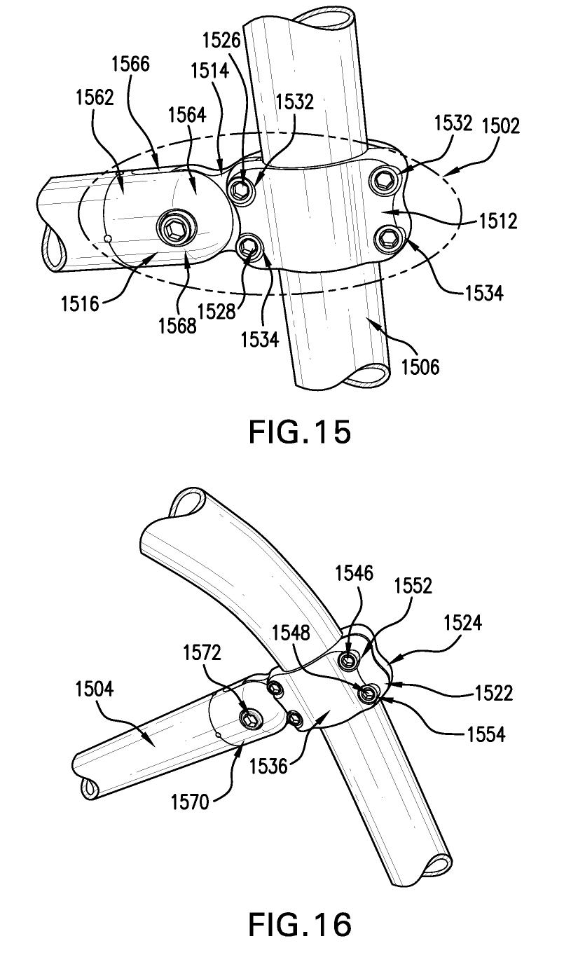

FIGS. 15, 16, 17 and 18 show a clamp assembly 1502 connecting a straight tubular support member 1504 to a curved tubular support member 1506. Clamp assembly 1502 includes a clamp component 1512, a pivot piece 1514 and a pivot mount 1516. Clamp component 1512 includes a front jaw 1522 and a rear jaw 1524. Front jaw 1522 and rear jaw 1524 are mounted on pivot piece 1514 by screws 1526 and 1528 that extend through apertures 1532 and 1534 in front jaw 1522, through respective apertures (not shown) in pivot piece 1514, and through respective apertures (not shown) in rear jaw 1524. Front jaw 1512 includes a clamping region 1536, while rear jaw 1514 includes clamping regions (not shown) that clamp tubular support member 1506. A clamping force on clamping regions 1536 and the clamping region of the rear jaw is provided by tightening screws 1546 and 1548 that extend through apertures 1552 and 1554 in front jaw 1522 and through respective apertures (not shown) in rear jaw 1524. Pivot mount 1516 has a cylindrical lower portion 1562, a hemispherical upper portion 1564 and a slot 1566. Pivot piece 1514 is fitted into slot 1566 so that a pivot aperture 1568 on front side 1570 of pivot mount 1516 aligns with a pivot aperture (not shown) in pivot piece 1514 and a pivot aperture (not shown) on a rear side (not shown) of pivot mount 1516. A screw 1572 extends through pivot aperture 1568, the aligned pivot aperture in pivot piece 1514 and the aligned pivot aperture on the rear side of pivot mount 1516. Pivot mount 1516 pivots during assembly on the shaft (not shown) of screw 1572. A nut (not shown) is tightened on an opposite end (not show) of screw 1572 to fix pivot mount 1516 in place relative to pivot piece 1514, and thereby, to fix tubular support member 1504 to in position relative to tubular support member 1506. Pivot mount is held on tubular support member 1504 by four screws 1576, only two of which are visible in FIGS. 15, 16, 17 and 18.

Although not used in the embodiment shown in FIGS. 15, 16, 17 and 18, a nut may be screwed on each of the opposite ends of screws 1526, 1528, 1546 and 1548 to provide additional tightening/clamping. Also, washers may be used with screws 1526, 1528, 1546 and 1548 and/or the nuts.

FIGS. 15, 16, 17 and 18 shows clamp component 1512 clamped to a curved portion 1582 of tubular support member 1506. In FIGS. 15, 16, 17 and 18, clamping regions 1532 and 1534 substantially complementarily clamp curved portion 1582 of tubular support member 1506.

To allow for better clamping on curved portions tubular support members, such as shown in FIGS. 16, 17, 18, the contacting interior surfaces of the two jaws may be contoured to match the curvature of the curved portion of the tubular support member to which the two jaws are clamped.

A clamp device of the present invention may be viewed as the two clamping jaws of the clamping component by themselves, as a clamping component in combination with the pivot piece, or as a clamping component in combination with both the pivot piece and the pivot mount i.e. the clamping assembly, with or without the screws, nuts, etc. used to connect the various components. Although in the embodiments shown in the drawing figures the two clamping jaws are shown as separate parts, the clamping jaws may be made as a single part i.e. the clamping jaws are made as a unibody jaws component. For example, a unibody jaws component could be made as a single part by a process such as casting.

The clamping component, pivot piece and pivot mount may be made of the same type of material or different types of material depending on the specific circumstances in which the clamp device/assembly of the present invention is used. In one embodiment, the clamping component, pivot piece and pivot mount are each made of metal. In one embodiment, the clamping component, pivot piece and pivot mount are each made of stainless steel.

The proximal gap between the proximal interior surfaces of the two jaws is sufficiently large that enough force can be exerted on the proximal ends of the two jaws to cause the contacting surfaces of the two jaws to clamp a tubular support member, without the proximal interior surface contacting each other i.e. “bottoming out”. The width of the proximal gap refers to the distance between the proximal interior surfaces of the two jaws. In one embodiment the proximal gap is about 0.090 in (2286 mm) in width.

For better gripping of the tubular member during clamping, the contacting interior surfaces of the two jaws may be coated with a coating such as a grit material or an adhesive to increase slide force resistance, pivoting torque resistance and twisting force resistance. On example of a grit material that may be used as a coating is tungsten carbide. A clamp device/assembly connecting two support members according to one embodiment of the present invention that has the interior surfaces of the clamp jaws coated with a tungsten carbide grit type coating may provide a slide resistance force of at least about 450 foot-pounds lbs (610 N-m) and about 500 foot-pounds (678 N-m) of pivoting torque resistance with respect to a support member on which the clamp device/assembly is clamped. A coating may provide a resistance force for the clamp that is about 50% greater than without the coating.

Although in the embodiments shown in the drawing figures the pivot piece is shown as a separate piece from the jaws, in one embodiment of the present invention the pivot piece may be a part of one of the jaws i.e. one of the jaws and the pivot piece are made as a unibody jaw-pivot piece component. Such a unibody jaw-pivot piece component could be made by as a single part by a process such as casting.

In another embodiment of the present invention the clamp device may be made as a single part that includes the two jaws and the pivot piece i.e. the two jaws and the pivot piece are made as a unibody jaws-pivot piece component. Such a unibody jaws-pivot piece component could be made as a single part by a process such as casting.

Although one particular type of pivoting mechanism is shown in the drawings for pivotably mounting a pivot mount on a pivot piece, various types of pivoting mechanisms may be used. For example, bolts may be used instead of a screw as an elongated member on which the pivot mount pivots. In another embodiment of the present invention, instead of the pivoting mechanism two aligned apertures in the pivot mount, one aligned aperture in the pivot piece, and an elongated member that extends through the aligned apertures as shown in the drawings, the pivot piece may include two aligned apertures and the pivot mount may include just one align aperture. The present invention contemplates that there may be any number of aligned apertures in the pivot piece and/or pivot mount.

In other embodiments, the elongated member of the pivoting mechanism may be part of the pivot mount and the pivot mount may be pivotably mounted on the pivot piece by extending the elongated member through one or more apertures in the pivot piece. In other embodiments, the elongated member of the pivoting mechanism may be part of the pivot piece and the pivot mount may be pivotably mounted on the pivot piece by extending the elongated member through one or more apertures in the pivot mount.

The pivot mount may be mounted on the end of a support member in a variety of ways besides welding. For example, the pivot mount may be mounted on the end of a tubular support member by swedging, press fitting, clamping or an adhesive.

Two support members may be connected together using the clamp device of the present invention in a variety of ways. For example, the clamping component, pivot piece and pivot mount could be assembled into a clamp assembly. Then the pivot mount could be mounted on the end of one of the support members and the clamping component clamped to the other support member. In an alternative embodiment, the pivot member could be mounted on the end of one of the tubular members, a clamp device including both the clamping component and pivot piece could be mounted on the other of the tubular members, and then the pivot mount could be connected to the clamp device by pivotably mounting the pivot mount on the pivot piece of the clamp device. In yet another alternative embodiment, the clamp device could be assembled on a support member by joining the two jaws of the clamping component in a clamping configuration. The present invention contemplates a variety of ways of connecting together two support members.

The present also contemplates using multiple clamp devices and pivot mounts of the present invention to connect together tubular supports to assemble all or part of a roll cage assembly.

Although only hollow tubular support members with circular cross-sections are shown in FIGS. 11, 12, 13, 14, 15, 16, 17 and 18, the support members of the present invention may be solid and have a variety of cross-sectional shapes. When the support members have cross-sectional shapes other than the circular cross-sectional shapes of the support members shown, the clamping regions may have various shapes to provide complementary clamping to such support members.

Also, although in FIGS. 11, 12, 13, 14, 15, 16, 17 and 18, the two support members being connected using the clamp device/assembly of the present invention are identical in cross-sectional shape and diameter, the two support members being connected may have different cross-sectional shapes and diameters.

In addition, although in FIGS. 11, 12, 13, 14, 15, 16, 17 and 18, the support members shown are elongated i.e. have a length that is substantially greater than their diameter, the support members of the present invention may be a variety of lengths.

In addition for use in assembly roll bar and roll cage assemblies, the clamp device of the present invention may also be used in other applications such as assembling off-road and all-terrain vehicles, golf carts, industrial scaffolding, boats, sails, aircraft, hang-gliders, tents, etc.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A device comprising:
a clamping component comprising two opposing jaws, each of the jaws including:
a proximal end opposing the proximal end of the other jaw and separated from the proximal end of the other jaw by a proximal gap;
a distal end; and
a contacting region opposing the contacting region of the other jaw;
a pivot piece including a fixed mounting portion and a pivotable mounting portion; and
a pivot mount comprising:
a base for mounting the pivot mount on an end of a first support member; and
two support structures extending from the base of the pivot mount;
wherein the fixed mounting portion of the pivot piece is fixedly mounted between the respective distal ends of the two jaws;
wherein the pivotable mounting portion of the pivot piece is pivotably mounted between the two support structures of the pivot mount; and
wherein when the opposing proximal ends of the two jaws are forced towards each other, the opposing contacting regions of the two jaws at least substantially complementarily clamp a second support member located between the opposing contacting regions to thereby hold the clamp component to the second support member.

2. The device of claim 1, wherein when the opposing proximal ends of the two jaws are forced towards each other, the opposing contacting regions of the two jaws complementarily clamp the second support member located between the opposing contacting regions.

3. The device of claim 1, wherein when the opposing proximal ends of the two jaws are forced towards each other, the opposing contacting regions of the two jaws complementarily clamp a straight region of the second support member located between the opposing contacting regions.

4. The device of claim 1, further including a clamping mechanism for forcing the opposing proximal ends toward each other to thereby cause the contacting regions of the two jaws to clamp the first support member.

5. The device of claim 4, wherein the clamping mechanism comprises one or more screws and/or bolts that extend through the proximal end of one of the jaws and at least into the proximal end of the other jaw.

6. (canceled)

7. The device of claim 1, wherein the fixed mounting portion is fixedly mounted between the respective distal ends of the two jaws by two or more screws that extend through aligned apertures in the two distal ends and the pivot piece pivot component.

8. (canceled)

9. (canceled)

10. (canceled)

11. The device of claim 1, wherein the pivotable mounting portion of the pivot piece is pivotably mounted between the two support structures of the pivot mount by an elongated member that extends through an aperture in the pivot mount and a respective aperture in each of the two support structure.

12. (canceled)

13. (canceled)

14. (canceled)

15. The device of claim 11, wherein the device further comprises a tightening device mounted on one end of the elongated member that may be tightened to prevent the pivot mount from pivoting relative to the pivot piece.

16. The device of claim 15, wherein the tightening device comprises a nut.

17. (canceled)

18. The device of claim 1, wherein the first and/or second support member comprises a tubular support member.

19. A method comprising the following steps:
(a) pivoting a pivot mount and/or a clamp device of a clamp assembly to a desired angle with respect to each other;
(b) fixing the clamp assembly at the desired angle by preventing the pivot mount from pivoting relative to the clamp device;
(c) clamping the clamp device to the first support member by forcing towards each other respective proximal ends of two jaws of the clamp device so that opposing contacting regions of the two jaws at least substantially complementarily clamp the first support member between the two jaws; and
(d) mounting the pivot mount on a second support member, wherein after steps (a), (b), (c) and (d) are performed, the clamp assembly connects the first and second support members to each other in a desired fixed position.

20. The method of claim 19, wherein steps (a) and (b) are performed before steps (c) and (d).

21. The method of claim 19, wherein steps (c) and (d) are performed before steps (a) and (b).

22. The method of claim 19, wherein step (c) is performed before steps (a), (b) and (d).

23. The method of claim 19, wherein step (d) is performed before steps (a), (b) and (c).

24. The method of claim 19, further comprising the following step:
(e) pivotably mounting the pivot mount on a pivot component of the clamp device.

25. The method of claim 24, wherein the pivot mount is pivotably mounted on the clamp device by an elongated member that extends through aligned apertures in the pivot mount and clamp device and wherein step (b) comprises tightening a tightening device mounted on one end of the elongated member.

26. The method of claim 25, wherein the tightening device comprises a nut.

27. The method of claim 24, wherein step (e) is performed before steps (c) and (d).

28. The method of claim 24, wherein steps (c) and (d) are performed before step (e).

29. The method of claim 24, wherein step (c) is performed before step (e).

30. The method of claim 24, wherein step (d) is performed before step (e).

31. The method of claim 24, wherein steps (a), (b), (c), (d) and (e) are each repeated two or more times for two or more sets of first and second support members to thereby form at least part of a roll cage assembly.

32. The method of claim 19, wherein the clamp device comprises a pivot component and the two jaws and wherein the pivot component includes part of a pivot mechanism used to pivotably mount the pivot mount on the clamp device.

33. The method of claim 32, wherein the pivot component and two jaws are part of a unibody jaws-pivot piece component.

34. The method of claim 32, wherein the pivot component and one of the jaws comprise a unibody jaw-pivot piece component, and wherein the method further comprises the following step:
(f) joining the jaw-pivot piece to the other jaw.

35. The method of claim 32, wherein the pivot component comprises a pivot piece, wherein the two jaws comprise a unibody jaws component, and wherein the method further comprises the following step:
(f) joining the jaws component to the pivot piece.

36. The method of claim 32, wherein the pivot component comprises a pivot piece, wherein the two jaws are separate parts, and wherein the method further comprises the following steps:
(f) joining the jaws to the pivot piece.

37. The method of claim 32, wherein the pivot mount is pivotably mounted on the clamp device by an elongated member that extends through aligned apertures in the pivot mount and pivot component and wherein step (b) comprises tightening a tightening device mounted on one end of the elongated member.

38. The method of claim 37, wherein the tightening device comprises a nut.

39. The method of claim 19, wherein the pivot mounted is mounted at one end of the second support member.

40. The method of claim 19, wherein the pivot mount is welded to the support member.

41. The method of claim 19, wherein the two jaws complementarily clamp the first support member between the two jaws.

42. The method of claim 19, wherein the contacting region of each of the jaws has a coating comprising a grit material applied thereon.

43. The method of claim 42, wherein the grit material comprises tungsten carbide.

44. The method of claim 19, wherein the contacting region of each of the jaws has an adhesive coating applied thereon.

45. The method of claim 19, wherein the two jaws complementarily clamp a straight region of the first support member between the two jaws

46. The method of claim 19, wherein the first and/or second support member is at least partially curved.

47. The method of claim 46, wherein the first support member is at least partially curved and the two jaws at least substantially complementarily clamp a curved region of the first support member between the two jaws.

48. The method of claim 19, wherein the first and/or second support members comprise a tubular support member.

49. The method of claim 19, wherein steps (a), (b), (c) and (d) are each repeated two or more times for two or more sets of first and second support members to thereby form at least part of a roll cage assembly.

50. The device of claim 1, wherein when the clamp component is held to the second support member, the proximal gap still exists between the opposing proximal ends.
